(19) United States
(12) Patent Application Publication
(10) Pub. No.: US 2004/0029594 A1
(43) Pub. Date: Feb. 12, 2004

(54) Method for using information of a station for providing information, communications terminal, master station, and station of an information provider

(76) Inventors: Axel Brandes, Lahnstedt (DE); Cornelius Hahlweg, Hamburg (DE)

Correspondence Address: KENYON & KENYON, ONE BROADWAY, NEW YORK, NY, 10004, US

(21) Appl. No.: 10/381,510

(22) PCT Filed: Sep. 7, 2001
(86) PCT No.: PCT/DE01/03446

(30) Foreign Application Priority Data
Sep. 22, 2000 (DE) 100 46 991.4

(51) Int. Cl. H04Q 7/00

(52) U.S. Cl. 455/456.1; 455/432.1; 455/404.2; 455/422.1

(57) ABSTRACT

Proposed are a method for using information of a station (1) of an information provider, a communications terminal (5), a master station (15), and the station (1) of the information provider, which allow a location information code to be queried from the station (1) of the information provider in a terminal-independent manner. In this context, the intention is for the information of the information provider to be usable in the form of location information in an application (10), in particular a navigation application, that can be used by the communications terminal (5). A location information code associated with the location information is queried by the station (1) from the master station (15). In the case that the communications terminal (5) queries the location information from the station (1), the location information code is transmitted by the station (1) to the communications terminal (5). Together with a query of the associated location information, the received location information code and an application code associated with the application (10) that is usable by the communications terminal (5) are transmitted by the communications terminal (5) to the master station (15). The location information associated with the location information code is processed by the master station (15) as a function of the application code, in such a way, that it can be used by the application (10) after being transmitted the communications terminal (5).

### BACKGROUND INFORMATION

The present invention is based on a method for using information of a station for providing information, on a communications terminal, on a master station, and on a station of an information provider according to the species defined in the independent claims.

There are already known navigation applications in which information in the form of location coordinates is transmitted from the station of a service or information provider to a communications terminal, the navigation application being usable by the communications terminal.

If the location coordinates are transmitted from the station of the information provider to a communications terminal in the form of absolute location coordinates, then the formation of the images thereof on digital maps, for example by a navigation application, is faulty. This problem can be avoided if the properties of the digital map used by the communications terminal or by the application that is usable by the communications terminal are already known to the information provider in advance. The information provider can then generate location coordinates which are adapted to the communications terminal or to the application that is usable by this communications terminal, and which are no longer faulty when imaged onto the corresponding digital map of the communications terminal or of the application. Location coordinates generated in this manner are then no longer absolute location coordinates but location coordinates that are related to the communications terminal or the respective application.

### ADVANTAGES OF THE INVENTION

The method according to the present invention for using information of a station for providing information, the inventive communications terminal, the inventive master station, and the inventive station of an information provider having the features of the independent claims have the advantage over the background art that a location information code associated with the location information, in particular with the location coordinates, is queried by the station for providing information from the master station, that in the case that the communications terminal queries the location information from the station for providing information, the location information code is transmitted by the station for providing information to the communications terminal, that, together with a query of the associated location information, the received location information code and an application code associated with the application that is usable by the communications terminal are transmitted by the communications terminal to the master station, and there the location information associated with the location information code is processed by the master station as a function of the application code, in such a way, that it can be used by the application after being transmitted to the communications terminal. In this manner, the information provider can make available his/her geographic information independently of the possibilities and properties of the particular querying communications terminal or of the application that is usable by this communications terminal. The association of the geographic information made available by the information provider with the properties of the respective communications terminal or the application thereof is carried out centrally, reducing the effort at the individual information providers. The geographic information offered by the information provider in the form of location information is then only location-related and no longer map- or application-related. The correlation to the map or application is accomplished by the master station for arbitrary information providers. The correlation to the location and the correlation to the map or application of the information supplied by the information provider are thus separate from each other. Consequently, the information provided does not need to have knowledge of the possibilities and properties of the querying communications terminal or of the application that is usable by the communications terminal, making it possible to save effort and cost to the information provider and allowing the information provider to offer the information at a lower cost.

Advantageous refinements and improvements of the method for using information of a station for providing information, of the communications terminal, of the master station, and of the station for providing information according to the independent claims are made possible by the measures specified in the dependent claims.

It is particularly advantageous that the location information associated with the location information code is encoded by the master station as a function of the application code in such a way that the location information can be uniquely decoded by the application. In this manner, the location information can be adapted to the properties of the querying communications terminal or of the application that is usable by the communications terminal in a simple and centralized manner, i.e., independently of the respective information provider. The use of a code for processing the location information, makes it possible to establish a unique association with the querying communications terminal and, consequently, with the possibilities and properties of this communications terminal or of the application that is usable by the communications terminal, ruling out incorrect evaluation of the location information at the querying communications terminal.

The effort for processing the location information to be transmitted by the master station to the communications terminal can be further reduced if the processed location information is transmitted by the master station to the communications terminal as location information which is associated with the location information associated with the location information code as a function of the application code and stored in the master station. Thus, the location information is already available in such a form that it is processed for the querying communications terminal or the application that is usable by the communications terminal. Therefore, the location information does not have to be processed anew each time the communications terminal makes a query. Rather, it is sufficient for the location information to be processed a single time and subsequently stored in the master station so that each time the communications terminal makes a query, it can just be read out from the memory and transmitted to the telecommunications terminal, possibly after an additional coding. This saves computational effort in the master station. The processing of the location information upon a query by the communications terminal then only consists in that the location information, which is already adapted to the querying communications terminal or to the application that is usable by the communications terminal, is taken from the memory of the master station and, possibly, additionally encoded.

A further advantage is that the master station receives location information from the station for providing information and contains a comparator device that determines a location information code which is associated with the received location information and stored in the memory and which is transmitted by the master station to the station for providing information. In this manner, the functionality of the master station is increased, and the location information code which is anyway known in the master station for determining the location information queried by the communications terminal is also made available to a querying station for providing information. Thus, the method according to the present invention can be implemented with the lowest possible complexity and cost.

### DRAWING

An exemplary embodiment of the present invention is depicted in the drawing and will be explained in greater detail in the following description.

FIG. 1 shows a block diagram including a station for providing information, a master station, and a communications terminal for implementing the method according to the present invention;

FIG. 2 provides a flow chart to illustrate the query of location coordinates by the communications terminal;

FIG. 3 shows a flow chart to describe the query of a location coordinate code by the station for providing information; and

FIG. 4 shows a schematic representation with respect to the transmission of location information from the master station to an application of the communications terminal.

### DESCRIPTION OF THE EXEMPLARY EMBODIMENT

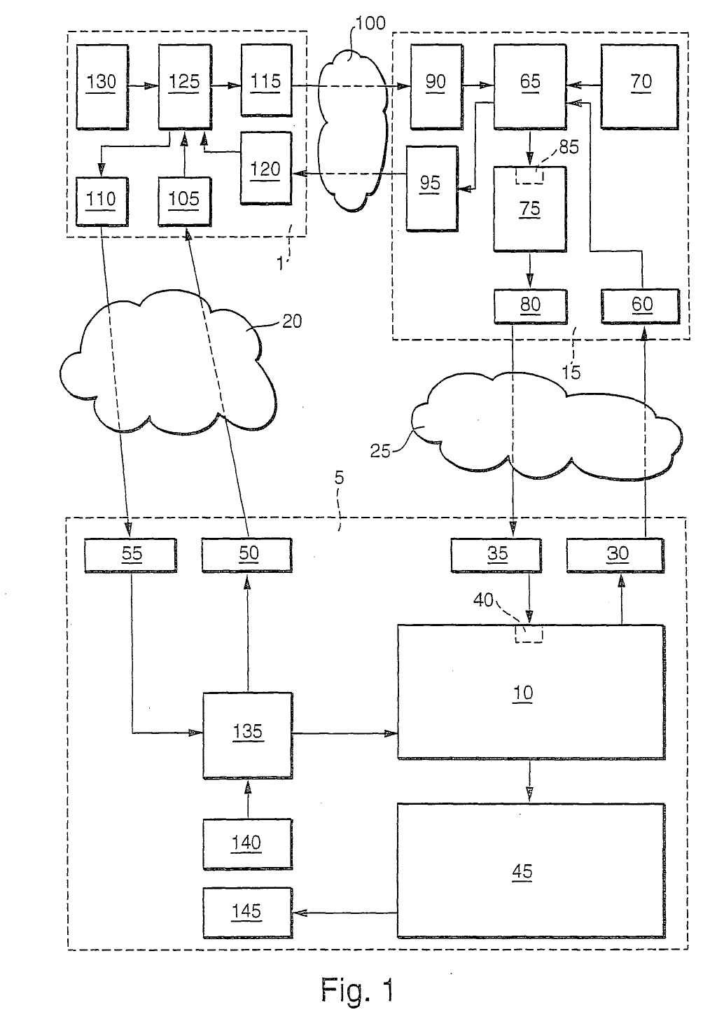

In FIG. 1, 5 denotes a communications terminal including a first transmitting device 30, a first receiving device 35, a second transmitting device 50, and a second receiving device 55. Second transmitting device 50 and second receiving device 55 are used for communication over a first communication network 20. First transmitting device 30 and first receiving device 35 are used for communication over a second communication network 25. Provision can be made for the two communication networks 20, 25 to be different from each other, as shown in FIG. 1. However, provision can also be made for the two communication networks 20, 25 to be one and the same communication network. In the latter case, only a single transmitting device and a single receiving device would then be required in communications terminal 5. Moreover, provision could be made to implement the communication over the two different communication networks 20, 25 shown in FIG. 1 using only a single transmitting device and only a single receiving device which would then have to be appropriately switched as a function of the communication network that is currently used for the transmission. However, the present invention will be described below in accordance with the exemplary embodiment shown in FIG. 1 with separate transmitting and receiving devices and communication networks 20, 25 which are different from each other.

Communications terminal 5 further contains a control unit 135 to which are connected second transmitting device 50 and second receiving device 55, and which is also connected to an application module 10 and an input unit 140. Application module 10 is used to implement an application. In this example, the application uses a digital map to describe route sections using location information in the form of location coordinates. In the following, it is assumed, by way of example, that the application is designed as a navigation application, application module 10 being connected to a route guidance unit 45 which generates route guidance information regarding a selected destination on the digital map and reproduces the information at an output unit 145, for example, a visual indicating device in the form of a display. Moreover, application device 10 is also connected to first transmitting device 30 and first receiving device 35. Optionally, it can contain a decoding device 40 which decodes encoded location coordinate information received by first receiving device 35.

Also shown in FIG. 1 is a master station 15 containing a third transmitting device 80 and a third receiving device 60 for communication over second communication network 25. Master station 15 further contains a fourth transmitting device 95 and a fourth receiving device 90 for communication over a third communication network 100. In this context, again, provision can be made for second communication network 25 and third communication network 100 to be different from each other, as shown in FIG. 1. However, provision can also be made for second communication network 25 and third communication network 100 to correspond to each other. In this case, only a single transmitting device and a single receiving device would be required. In the case shown in FIG. 1, where second communication network 25 is different from third communication network 100, it would also possible to provide only a single transmitting device and a single receiving device in master station 15, which would then in each case have to be switched as a function of the communication network currently used. However, according to FIG. 1, it is assumed in this example that one transmitting device and one receiving device are provided in master station 15 for each of second communication network 25 and third communication network 100.

Master station 15 further contains a comparator device 65 which is connected to fourth transmitting device 95 and fourth receiving device 90 and to which are also connected a processing device 75, a first memory 70, and third receiving device 60. Processing device 75 can optionally contain an encoding device 85 which is directly connected to comparator device 65. Also connected to processing device 75 is third transmitting device 80.

In FIG. 1, 1 denotes a station for providing information, which is operated by an information or service provider, as well as a fifth transmitting device 110 and a fifth receiving device 105 for communication over first communication network 20. Station 1 further contains a sixth transmitting device 115 and a sixth receiving device 120 for communication over third communication network 100. According to FIG. 1, first communication network 20 is different from third communication network 100. However, provision could also be made for first communication network 20 to correspond to third communication network 100, in which case only a single transmitting device and a single receiving device would be required in station 1. Also in the case that first communication network 20 and third communication network 100 are different from each other, as shown in FIG. 1, it would also be possible to provide only a single transmitting device and a single receiving device for these two communication networks 20, 100 in station 1. In this case, however, the single transmitting device and the single receiving device of station 1 would have to be appropriately switched or adjusted as a function of the communication network that is currently used for the transmission.

Station 1 further contains a control unit 125 which, according to FIG. 1, is connected to fifth transmitting device 110, fifth receiving device 105, sixth transmitting device 115, and to sixth receiving device 120. Moreover, a second memory 130 is connected to control unit 125.

The mode of operation of the devices shown in FIG. 1 is described below. In the following, by way of example, it is assumed that first communication network 20 is the Internet, second communication network 25 is a mobile radio network, for example, according to the GSM standard (Global System for Mobile Communications) or according to the UMTS standard (Universal Mobile Telecommunications System), and that third communication network 100 is a fixed network, for example, according to the ISDN standard (Integrated Services Data Network). Communications terminal 5 can be designed, for example, to be mobile; it being possible for the access to Internet 20 to be also accomplished over mobile radio network 25 using the so-called “WAP” (Wireless Application Protocol). In this case, again, it would be sufficient to provide communications terminal 5 with only a single transmitting device and a single receiving device which are suitable for communication over the mobile radio network and which make use of WAP in case of communication over Internet 20. A correspondingly necessary switching of such a single transmitting device and such a single receiving device between WAP and conventional communication over mobile radio network 25 can then be carried out by control unit 135 of communications terminal 5. However, for the sake of clarity, separate transmitting and receiving devices are provided according to FIG. 1 to depict and describe the communication over Internet 20 separately from the communication over mobile radio network 25.

A transmitting device and a receiving device used for communication over the same communication network can optionally also be combined into a common transmitting and receiving device if they are located in the same unit.

In this example, communications device 5 is located in a motor vehicle. Application module 10, route guidance unit 45, and output unit 145 can also be arranged outside of communications terminal 5 and in association therewith while maintaining the connections depicted in FIG. 1 and described above between the individual elements. The user of communications terminal 5 and driver of the motor vehicle now wishes to activate a route guidance to a destination selected by him/her using the navigation application implemented by application module 10, the route guidance information being intended to be reproduced at output unit 145. In this context, the reproduction can be carried out in visual and/or audible form. In this example, it is assumed to be carried out visually with the aid of a visual indicating device or display. In this context, the destination can be selected by the user at input unit 140 and made available to application module 10 via control unit 135 of communications terminal 5. Another way for the user to determine the destination is to specify a destination again via input unit 140, however, not by direct entry but by searching in Internet 20. In this context, it is assumed that the user hits the homepage of the information provider who operates station 1. The information provider can be, for example, the operator of a parking garage who wants to distribute information on this parking garage via Internet 20. The user of communications terminal 5 is interested in a route guidance to this parking garage.

The now following sequence is described with reference to the flow chart according to FIG. 2. At program point 200, using an appropriate mouse click at input unit 140, the user of communications terminal 5 initiates, via second transmitting device 50 and Internet 20, a query for a location coordinate code associated with the parking garage. The query for the location coordinate code is received in station 1 via fifth receiving device 105 and evaluated by control unit 125 of station 1. Control unit 125 of station 1 determines the location coordinate code associated with the parking garage from second memory 130 and causes fifth transmitting device 110 to transmit this location coordinate code over Internet 20 to second receiving device 55. At a program point 205, the location coordinate code is then received in second receiving device 55 and passed on to application module 10 via control unit 135 of communications terminal 5. Subsequently, a branch is made to a program point 210. At program point 210, application module 10 containing the navigation application causes first transmitting device 30 to query location coordinates from master station 15 over mobile radio network 25; the location coordinate code determined by station 1 and an application code associated with the navigation application being transmitted to master station 15 with this query. Third receiving device 60 receives the query with the location coordinate code and the application code and passes it on to comparator device 65. At program point 215, the location coordinates of the parking garage that are associated with this location coordinate code and stored in memory 70 are determined by comparator device 65 on the basis of the received location coordinate code. These are absolute location coordinates whose description on the digital map of the navigation application can be faulty because they are not adapted to this digital map and the navigation application. Therefore, the determined location coordinates are passed on to processing device 75 at subsequent program point 220 and processed by processing device 75 as a function of the received application code such that they can be faultlessly described or represented in the digital map of the navigation application. For this purpose, the properties and possibilities of the navigation application and its digital map are known in processing device 75. At the output of processing device 75, the location coordinates are now present in a form that is readable by the navigation application in communications terminal 5. At following program point 225, they are transmitted by third transmitting device 80 over the mobile radio network 25 to first receiving device 35 and received by first receiving device 35. At following program point 230, first receiving device 35 passes the processed location coordinates received on to application module 10, where they can be uniquely detected and faultlessly represented on the digital map of the navigation application. Subsequently, the program is exited, and application module 10 causes route guidance unit 45 to reproduce route guidance information at output unit 145 to guide the user of communications terminal 5 or of the motor vehicle to the destination on the digital map that is described by the location coordinates received from master station 15.

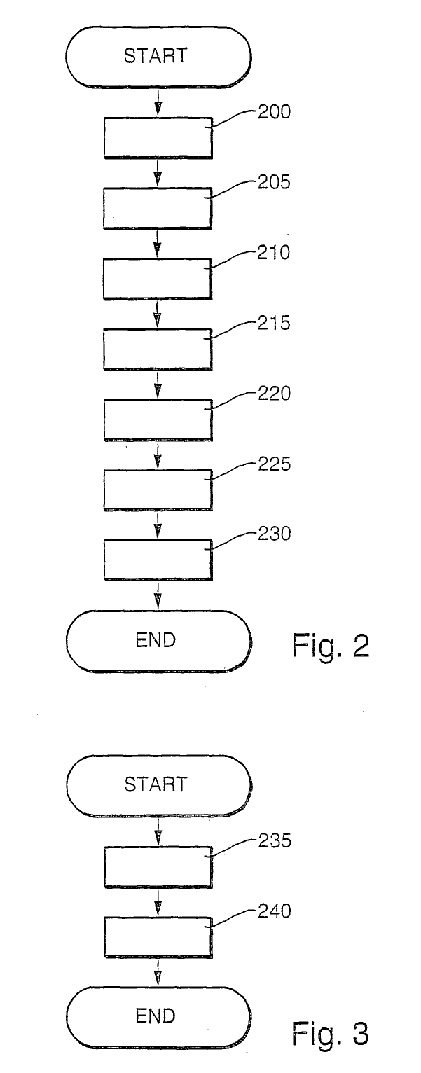

The manner in which station 1 queries the location coordinate code from master station 15 will now be described by a flow chart with reference to FIG. 3. At a program point 235, for example, due to an entry at an input unit not shown in FIG. 1, control unit 125 of station 1 causes a query for a location coordinate code to be transmitted with the aid of sixth transmitting device 115 to master station 15 over third communication network 100. In this context, the query for a location coordinate code contains the specification of the absolute location coordinates of the parking garage indicated on the homepage of the information provider, which are also able to be entered at the input unit of station 1 that is not shown in FIG. 1, or which can be taken by control unit 125 of station 1 from second memory 130. Master station 15 receives this query for a location coordinate code together with the location coordinates via fourth receiving device 90 and passes the query for a location coordinate code together with the location coordinates on to comparator device 65. Using the absolute location coordinates received, comparator device 65 determines the location coordinate code that is stored in first memory 70 in association with these location coordinates and, at a program point 240, causes its transmission via fourth transmitting device 95 to station 1 over the third communication network. There, the location coordinate code is received via sixth receiving device 120. Then, control unit 125 of station 1 causes this location coordinate code to be stored in second memory 130 in association with the parking garage data. Subsequently, the program is exited.

During the processing of the location coordinates by processing device 75, provision can be made that the location coordinates, after being read out from first memory 70, are encoded by encoding device 85 in such a manner that, upon receipt by application module 10, they can be uniquely decoded by decoding device 40 present there. In this connection, provision can be made for identifiers to be added to the location coordinates through the coding by encoding device 85, the identifiers also being uniquely decodable by decoding device 40 and containing control information for describing the transmitted location coordinates on the digital map, this control information being specifically designed for application module 10 and the navigation application running there, and thus being able to be processed by application module 10. In this case, further processing in processing device 75 is no longer absolutely necessary and can therefore be dispensed with so that the processing in processing device 75 is, in this case, only carried out by encoding device 85.

Additionally or alternatively, provision can be made that the location coordinates are present in first memory 70 already in processed form both in association with the location coordinate code and in association with the application code, and that they can just be taken by comparator device 65 from first memory 70 on the basis of the location coordinate code and the application code received from communications terminal 5 and be directly transmitted with the aid of transmitting device 80 to communications terminal 5 without further processing. An additional coding of the so-determined, already processed location coordinates by encoding device 85 is, of course, also possible but not required, and can be reversed again by decoding device 40 in application module 10, allowing the location coordinates to be uniquely decoded in application module 10.

In this context, this coding can also be carried out in the described manner as a function of the application code and be adapted to the specific navigation application of application module 10. In the case that the location coordinates are already present in first memory 70 in processed form as location coordinate information as described, the processing of the location coordinates needs to be carried out only once prior to storing the location coordinate information resulting from the processing in first memory 70 and does not have to be carried out each time communications terminal 5 queries location coordinates in master station 15. In this case, the processing of the location coordinates by processing device 75 simply consists in that processing device 75 takes the location coordinate information from first memory 70 via comparator device 65 and delivers this information to third transmitting device 80, it being possible for an optional coding to be carried out by encoding device 85 in the described manner.

The possible coding by encoding device 85 is carried out as a function of the application code received from communications terminal 5 in such a way that the location coordinates, after being decoded by decoding device 40, are present in application module 10 in a form in which they can be used by the navigation application and described or represented on the digital map so that a route guidance by route guidance unit 45 can be accomplished with these location coordinates as the destination.

In the exemplary embodiment according to FIG. 1, first communication network 20 is designed to be the Internet. In this case, provision can also be made that the location coordinate code for the parking garage here specified by way of example can be stored, especially in encoded form, on the Internet page of the information provider, thus being able to be queried by communications terminal 5 via this Internet page so that so that fifth receiving device 105 and fifth transmitting device 110 as well as the readout of the location coordinate code from second memory 130 are not necessary for this process. The mentioned components can nevertheless be used together with control unit 125 of station 1 in the manner described above to determine the location coordinate code queried by communications terminal 5 independently of whether or not first communication network 20 is designed to be the Internet. If the location coordinate code is stored on the Internet page in encoded form, decoding is required in communications terminal 5 unless the location coordinate code is also present in master station 15 in correspondingly encoded form.

The query of the location coordinate code for the location coordinates of the parking garage here specified by way of example can also be accomplished in that, after establishing a communication connection over third communication network 100 to master station 15, the operator of station 1 himself/herself searches the location coordinates of the parking garage in the data base stored in first memory 70 via an input unit of station 1 not shown in FIG. 1, it being possible for the data base to be stored in first memory 70 in the form of a digital map. This digital map can be indicated in visual and/or audible form at a reproducing unit of station 1 not shown in FIG. 1 to allow the operator of station 1 to find the parking garage on the digital map. The condition is that the location coordinates stored in first memory 70 can be faultlessly reproduced at the reproducing unit of station 1. To this end, it can also be required for station 1 to transmit a reproduction code to master station 15, on the basis of which master station 15 can process the location coordinates from first memory 70 to be transmitted station 1 such that they can be faultlessly represented at the reproducing unit of station 1. The location coordinates selected at station 1 in this manner are then transmitted together with the query for a location coordinate code to master station 15 in the described manner to obtain the associated location coordinate code from master station 15. In order to initiate the selection of the location coordinates on a map represented or reproduced at station 1, it is not absolutely necessary to send the query for a location coordinate code to master station 15. This is only really necessary if location coordinates were selected at station 1 for which the location coordinate code is required. The transmission of location coordinates from master station 15 to station 1 for the purpose of representing these location coordinates on a digital map at the reproducing device of station 1 can also be initiated by a suitable map representation query on the part of station 1.

The data base stored in first memory 70 can contain all location coordinates referenced in any digital maps of arbitrary applications. In the context, each location coordinate pair or each geographic point is ideally associated with a globally unique location coordinate code and a specific location coordinate information for each supported digital map or each supported application, respectively, the specific location coordinate information including a location coordinate pair which is processed for the corresponding application. Thus, this location coordinate information adapted to the digital map or to the application associated therewith and can therefore be faultlessly represented or described on this associated digital map.

By an agreement between all relevant providers of digital maps or of applications using digital maps, master station 15 could always be provided with the up-to-date location coordinates processed for these maps, with the location coordinates being associated with the respective application code. Then, master station 15 itself can reference the processed location coordinates of the different applications in each case by a common location coordinate code that are based on the same absolute location coordinates. This generally computationally intensive referencing can then be carried out centrally in master station 15 and does no longer have to be carried out at each information provider, i.e., each station 1 so that less computational effort is required in stations 1. Thus, master station 15 can supply a plurality of stations 1 with location coordinate codes in the described manner.

Third communication network 100 can also be designed to be a mobile radio network or the Internet, and second communication network 25 can also be designed to be a fixed network or the Internet. Correspondingly, first communication network 20 can be designed to be a mobile radio network or a fixed network.

Besides the processing of the location coordinates by master station 15, the described method is generally suitable for processing location information for application 10 that can be used by communications terminal 5. Such location information that is processed by master station 15 for application 10 of communications terminal 5 can, for example, also be location designations or location names as well as the supplementation of a location data base of application 10.

Thus, in the example described, master station 15 can determine the associated application 10 by the received application code during a location coordinate query of communications terminal 5, the location data base underlying this application 10 being known in master station 15 as well. Thus, master station 15 recognizes, for example, that the access to the parking garage whose location coordinates are requested by communications terminal 5 is not known in the data base of application 10 so that master station 15 sends to communications terminal 5 also corresponding location information on the access along with the location coordinates for the parking garage. This location information contains data on the geometry of the access at least up to the entry point of the access to a road that is known to application 10. A prerequisite for this is that application 10 of communications terminal 5 is actually able to process such location information, i.e., that the location data base of application 10 can, at least temporarily, be expanded. This can also be checked in master station 15 on the basis of the received application code.

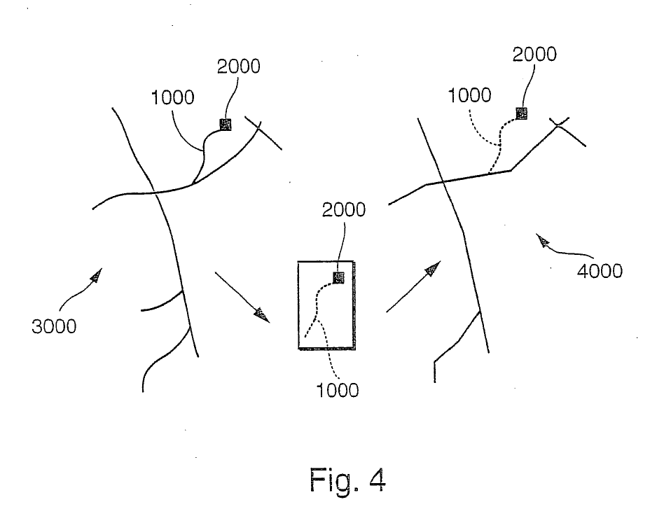

FIG. 4 schematically shows the transmission of location information 1000 on the access and location coordinates 2000 of the parking garage from master station 15, whose location data base 3000 contains both location information 1000 on the access and location coordinates 2000 of the parking garage, to application 10 of communications terminal 5, whose location data base 4000 originally does not contain this location information 1000 and location coordinates 2000, as indicated by the dotted representation.

What is claimed is:

1. A method for using information of a station (1) of an information provider in the form of location information, in particular location coordinates, in an application (10), in particular a navigation application, that can be used by a communications terminal (5),
wherein a location information code associated with the location information is queried by the station (1) from a master station (15);
in the case that the communications terminal (5) queries the location information from the station (1), the location information code is transmitted by the station (1) to the communications terminal (5);
together with a query of the associated location information, the received location information code and an application code associated with the application (10) that is usable by the communications terminal (5) are transmitted by the communications terminal (5) to the master station (15); and
the location information associated with the location information code is processed by the master station (15) as a function of the application code, in such a way, that it can be used by the application (10) after being transmitted to the communications terminal (5).

2. The method as recited in claim 1,
wherein the location information associated with the location information code is encoded by the master station (15) as a function of the application code in such a way that the location information can be uniquely decoded by the application (10).

3. The method as recited in claim 1 or 2,
wherein the processed location information is transmitted by the master station (15) to the communications terminal (5) as location information data, in particular as location coordinate information, which are associated with the location information associated with the location information code as a function of the application code and stored in the master station (15.

4. The method as recited in claim 1, 2 or 3,
wherein the location information code is transmitted by the station (1) to the communications terminal (5) over a first communication network (20), in particular the Internet.

5. The method as recited in one of the preceding claims,
wherein the processed location information is transmitted by the master station (15) to the communications terminal (5) over a second communication network (25), in particular a mobile radio network.

6. A communications terminal (5) for carrying out a method according to one of the preceding claims,
wherein an application (10) is provided, which transmits a location information query, in particular a location coordinate query, together with a location information code queried from a station (1) of an information provider and an application code associated with the application (10), to a master station (15) with the aid of a first transmitting device (30);
a first receiving device (35) is provided which, subsequent to the query, receives location information from the master station (15) that is processed for use by the application (10), and passes the processed location information on to the application (10) for processing.

7. The communications terminal (5) as recited in claim 6,
wherein the first receiving device (35) feeds the processed location information received to a decoding device (40) of the application (10) which uniquely decodes the processed location information.

8. The communications terminal (5) as recited in claim 6 or 7,
wherein the application (10) is a navigation application and feeds the processed location information received to a route guidance unit (45) in order to generate route guidance information regarding a destination characterized by the processed location information.

9. The communications terminal (5) as recited in claim 6, 7 or 8,
wherein a second transmitting device (50) and second receiving device (55) are provided which form an interface to a first communication network (20), in particular the Internet, for communication with the station (1); and
the first receiving device (35) and the first transmitting device (30) form an interface to a second communication network (25), in particular a mobile radio network, for communication with the master station (15).

10. The communications terminal (5) as recited in one of the claims 6 through 9,
wherein the communications terminal (5) is designed to be mobile.

11. A master station (15) for carrying out a method according to one of the claims 1 through 5,
wherein a third receiving device (60) is provided which receives a location information code and an application code from a communications terminal (5);
a comparator device (65) is provided which determines location information which is associated with the location information code and stored in a memory (70);
a processing device (75) is provided which processes the determined location information as a function of the application code; and
a third transmitting device (80) is provided which sends the processed location information to the communications terminal (5).

12. The master station (15) as recited in claim 11,
wherein location information data, in particular location coordinate information, are stored in the memory (70) in association with the location information code and with the application code and correspond to the processed location information; and
the processing device (75) takes the coordinate information from the memory (70), and delivers it to the third transmitting device (80).

13. The master station (15) as recited in claim 11 or 12,
wherein an encoding device (85) is provided which encodes the location information as a function of the application code.

14. The master station (15) as recited in claim 11, 12, or 13,
wherein a fourth receiving device (90) is provided which receives location information from a station (1) of an information provider; and
the comparator device (65) determines a location information code which is associated with the received location information and stored in the memory (70); and
a fourth transmitting device (95) is provided which sends the location information code to the station (1).

15. The master station (15) as recited in one of the claims 11 through 14,
wherein the data exchange between the station (1) and the master station (15) is carried out over a third communication network (100), and the data exchange between the communications terminal (5) and the master station (15) is carried out over a second communication network (25), in particular a mobile radio network.

16. A station (1) of an information provider for carrying out a method as recited in one of the claims 1 through 5,
wherein a fifth receiving device (105) is provided which receives a query for a location information code, in particular a query for a location coordinate code, of a communications terminal (5); and
a fifth transmitting device (110) is provided which sends the queried location information code to the communications terminal (5).

17. The station (1) as recited in claim 16,
wherein a sixth transmitting device (115) is provided which sends the location information to a master station (15) together with a query for a location information code; and
a sixth receiving device (120) is provided which thereupon receives from the master station (15) the location information code associated with the location information.
